(19) United States
(12) Patent Application Publication
(10) Pub. No.: US 2009/0219266 A1
(43) Pub. Date: Sep. 3, 2009

(54) Pixel circuit arrays

(76) Inventors: Moo-sup Lim, Seoul (KR); Jung-chak Ahn, Yongin-si (KR); Kyoung-sik Moon, Hwaseong-si (KR); Sung-ho Choi, Seoul (KR); Kang-sun Lee, Yongin-si (KR)

Correspondence Address: HARNESS, DICKEY & PIERCE, P.L.C., P.O. BOX 8910, RESTON, VA, 20195, US

(21) Appl. No.: 12/379,142

(22) Filed: Feb. 13, 2009

(30) Foreign Application Priority Data
Feb. 13, 2008 (KR) 10-2008-0013009

(51) Int. Cl. G09G 5/00

(52) U.S. Cl. 345/205

(57) ABSTRACT

A pixel circuit array may include pixel circuits and/or a global reset transistor that has a first end connected to a second end of a reset transistor and is turned on or off in response a global reset signal. Each pixel circuit may include: a transmission transistor that may receive and/or transmit photocharges through ends of the transmission transistor in response to a transmission control signal; the reset transistor that may have a first end connected to the second end of the transmission transistor and may be turned on or off in response a reset control signal; a source-follower transistor that may receive a signal from the second end of the reset transistor and/or may be turned on or off in response the received signal; and/or a selection transistor that may be connected to the source-follower transistor and/or may be turned on or off in response a selection control signal.

### PRIORITY STATEMENT

This application claims priority from Korean Patent Application No. 10-2008-0013009, filed on Feb. 13, 2008, in the Korean Intellectual Property Office (KIPO), the entire contents of which are incorporated herein by reference.

### BACKGROUND

1. Field

Example embodiments relate to pixel circuit arrays. Also, example embodiments relate to pixel circuit arrays that can operate using global shutters.

2. Description of Related Art

Included in, for example, mobile phone cameras and/or digital still cameras, complementary metal oxide semiconductor (CMOS) image sensors capture images and/or convert the captured images into screen images that may be displayed on a display device.

For example, CMOS image sensors may capture images, may convert the captured images into electrical signals using a photoelectric device, may convert the electrical signals into digital image signals, and/or may output the digital image signals to a display device such as a liquid crystal display (LCD). The digital image signals output from the CMOS image sensors may be, for example, red, green, and blue image data signals.

Photoelectric devices, such as photodiodes, may generate photocharges proportional to the amount of light received. If highly intense light is incident on a photodiode, the photodiode may generate a greater amount of photocharges than it may store. Thus, photocharges may overflow the photodiode, and/or an abnormal screen may be displayed. In this case, the abnormal screen may refer, for example, to a white screen or a screen that may not be able to be properly recognized.

In order to prevent an abnormal screen from being generated when highly intense light is incident on a photoelectric device, a mechanical shutter may be used to control the amount of light that is incident on the photoelectric device.

However, the installation of a mechanical shutter may increase production costs and/or the size of an imaging apparatus. It also may limit an operating cycle of the imaging apparatus. Thus, mechanical shutters may be installed in expensive and/or high-quality cameras, but not in inexpensive and/or small-sized cameras.

Recently, pixel circuits having global shutters are being developed. Pixel circuits having a global shutter may perform a global shutter operation when a mechanical shutter is not available. However, the implementation of a global shutter may not be realized yet due to an amount of leakage current generated in a floating diffusion (FD) node. When leakage current is generated, screen sensitivity may be significantly reduced, that may translate into deterioration of the image quality of an image sensor.

The term “global shutter operation” may refer to an operation in which all photoelectric devices in a frame may simultaneously receive light, image signals photoelectrically converted by the photoelectric devices may be simultaneously transmitted to an FD layer, and/or image signals may be output from each sequentially selected row.

Global shutters may be used in inexpensive and/or small-sized cameras. Therefore, if installation of a global shutter is desired, a potential increase in the size of an image sensor also must be taken into consideration.

### SUMMARY

Example embodiments may provide pixel array circuits that may improve image quality and/or may implement a global shutter without increasing the size of an image sensor.

According to example embodiments, a pixel circuit array may include: a plurality of pixel circuits and/or a global reset transistor that may have a first end connected to a second end of a reset transistor of each of the pixel circuits and/or may be turned on or off in response to a global reset signal. Each of the pixel circuits may include: a transmission transistor that may receive photocharges from a photodiode through a first end of the transmission transistor and/or may transmit the received photocharges through a second end of the transmission transistor in response to a transmission control signal; the reset transistor that may have a first end connected to the second end of the transmission transistor and/or may be turned on or off in response to a reset control signal; a source-follower transistor that may receive a signal output from the second end of the reset transistor through a gate of the source-follower transistor and/or may be turned on or off in response to the received signal; and/or a selection transistor that may be connected to the source-follower transistor and/or may be turned on or off in response to a selection control signal.

### BRIEF DESCRIPTION OF THE DRAWINGS

The above and/or other aspects and advantages will become more apparent and more readily appreciated from the following detailed description of example embodiments, taken in conjunction with the accompanying drawings in which:

FIG. 1 illustrates a pixel circuit array according to example embodiments;

FIG. 2 is a timing diagram showing operating times for elements of the pixel circuit array of FIG. 1;

FIG. 3 illustrates the pixel circuit array of FIG. 1 in more detail; and

FIG. 4 is a general view of the pixel circuit array of FIG. 1.

### DETAILED DESCRIPTION OF EXAMPLE EMBODIMENTS

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions are exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

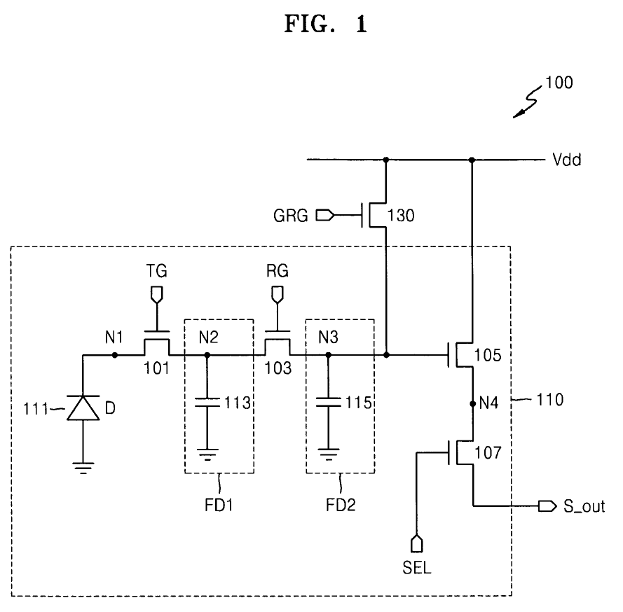

FIG. 1 illustrates pixel circuit array 100 according to example embodiments. Pixel circuit array 100 may include one or more pixel circuits and/or global reset transistor 130 (that may be shared among the one or more pixel circuits). The one or more pixel circuits may have a similar structure. Pixel circuit 110 in FIG. 1 illustrates an example structure of the one or more pixel circuits.

Referring to FIG. 1, pixel circuit array 100 may include global reset transistor 130 and/or pixel circuit 110. Pixel circuit 110 may include, for example, transmission transistor 101, reset transistor 103, source-follower transistor 105, and/or selection transistor 107.

Transmission transistor 101 may receive photocharges from photodiode 111 through a first end of transmission transistor 101 (i.e., at or near first node N1), and/or may transmit a received signal to a second end of transmission transistor 101 (i.e., at or near second node N2), in response to transmission control signal TG. The connection of photodiode 111 to transmission transistor 101 may be, for example, a serial connection.

Reset transistor 103 may have a first end (i.e., at or near second node N2) connected to the second end of transmission transistor 101 and/or a second end (i.e., at or near third node N3). The connection of transmission transistor 101 to reset transistor 103 may be, for example, a serial connection. Reset transistor 103 may be turned on and/or off in response to reset control signal RG.

Source-follower transistor 105 may have a gate terminal connected to the second end of reset transistor 103. Source-follower transistor 105 may be turned on and/or off in response to a signal transmitted to third node N3.

Selection transistor 107 may have a first end (i.e., at or near fourth node N4) connected to source-follower transistor 105. The connection of source-follower transistor 105 to selection transistor 107 may be, for example, a serial connection. Selection transistor 107 may be turned on and/or off in response to selection control signal SEL. In addition, selection transistor 107 may output image signal S_out via a second end of selection transistor 107. If pixel circuit array 100 includes a plurality of pixel circuits 110, then selection transistor 107 may output a plurality of image signals S_out. For example, selection transistor 107 may output an image signals S_out corresponding to each of the plurality of pixel circuits 110.

Global reset transistor 130 may have a first end (i.e., at or near third node N3) connected to reset transistor 103. Global reset transistor 130 may be turned on and/or off in response to global reset signal GRG. If pixel circuit array 100 includes a plurality of pixel circuits 110, then global reset transistor 130 may be connected to a plurality of reset transistors 103. For example, global reset transistor 130 may be connected to each of reset transistors 103.

A second end of global reset transistor 130 may be connected to high power supply voltage Vdd. Global reset transistor 130 may be shared by pixel circuits 110, that may be arranged, for example, in different rows of pixel circuit array 100, but in the same column of pixel circuit array 100.

Pixel circuit 110 may further include photodiode 111. If pixel circuit array 100 includes a plurality of pixel circuits 110, then each pixel circuit 110 may further include photodiode 111. Photodiode 111 may be connected to the first end of transmission transistor 101 (i.e., at or near first node N1). Photodiode 111 may accumulate photocharges by receiving light.

Pixel circuit 110 also may further include first floating diffusion (FD) node FD1 and/or second FD node FD2. If pixel circuit array 100 includes a plurality of pixel circuits 110, then each pixel circuit 110 may further include first floating diffusion (FD) node FD1 and/or second FD node FD2. First FD node FD1 may be formed at or near the second end of transmission transistor 101 (i.e., at or near second node N2). First FD node FD1 may receive and/or store photocharges collected by photodiode 111. Second FD node FD2 may be formed at or near the second end of reset transistor 103 (i.e., at or near third node N3). Second FD node FD2 may receive and/or store photocharges from first FD node FD1. First FD node FD1 may include first capacitor 113. Second FD node FD2 may include second capacitor 115.

First FD node FD1 may include no metal contact. In contrast, second FD node FD2 may include metal contact.

In order for a global shutter operation, a conventional pixel circuit may require a plurality of FD nodes and/or may require metal contacts to be formed in all of the FD nodes. Thus, when the conventional pixel circuit is used, it may be difficult to perform the global shutter operation (that, for example, may improve image quality) due to the generation of leakage current.

However, in pixel circuit array 100 according to example embodiments, first FD node FD1 of the pixel circuit 110 (or plurality of pixel circuits 110) may include no metal contact, for example, between second node N2 and a ground on the opposite side of first capacitor 113. In contrast, second FD node FD2 of the pixel circuit 110 (or plurality of pixel circuits 110) may include metal contact, for example, between third node N3 and a ground on the opposite side of second capacitor 115. In this way, the amount of leakage current generated when photodiode 111 stores received photocharges may be minimized. Accordingly, the global shutter operation (that, for example, may improve image quality) may be performed.

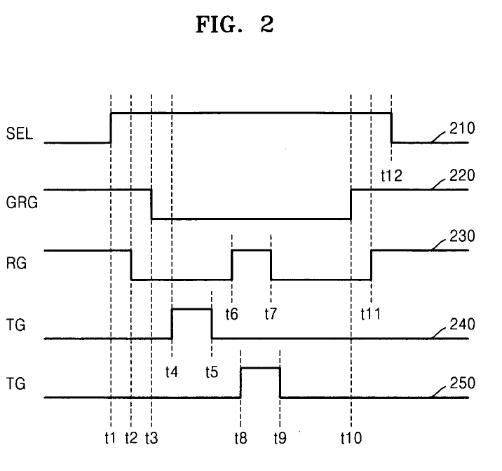

An ordinary operation and the global shutter operation of pixel circuit array 100 according to example embodiments will now be described with reference to FIGS. 2-4.

FIG. 2 is a timing diagram showing operating times for elements of pixel circuit array 100 of FIG. 1. Referring to FIG. 2, reference numeral 210 may indicate selection control signal SEL; reference numeral 220 may indicate global reset signal GRG; reference numeral 230 may indicate reset control signal RG; and/or reference numeral 240 may indicate transmission control signal TG. Transmission control signal TG also may be indicated by reference numeral 250.

Typical operation of pixel circuit array 100 will be described below. In a photographing mode, selection control signal SEL may transit from an inactive level (logic low) to an active level (logic high) at time t1. Selection control signal SEL may be maintained at the active level from time t1 until time t12. Accordingly, selection transistor 107 may be kept turned on.

For a correlated double sampling (CDS) operation, a reset signal may be output before an image signal. Generally, for CDS operation, an image signal may be output as the difference between a video signal and a reset signal. CDS operation is known to one of ordinary skill in the art.

Global reset signal GRG and/or reset control signal RG at the active level (logic high) may be transmitted until time t2. Accordingly, global reset transistor 130 and/or reset transistor 103 may be kept turned on until time t2. In addition, high power supply voltage Vdd may be applied to first FD node FD1 via third node N3 and/or reset transistor 103. As a result, first FD node FD1 may be reset.

After time t2, reset control signal RG may transit to the inactive level (logic low) and global reset signal GRG may be maintained at the active level until time t3. Accordingly, global reset transistor 130 may be turned on and reset transistor 103 may be turned off. As a result, second FD node FD2 may be reset by high power supply voltage Vdd.

After time t3, when a reset operation is completed, photocharges may be transmitted. That is, transmission transistor 101 may be turned on in a section from time t4 until time t5, during which transmission control signal TG may transit to the active level (logic high) and/or photocharges collected by photodiode 111 may be transmitted to and/or stored in first FD node FD1.

After the photocharges are stored in first FD node FD1, reset control signal RG at the active level (logic high) may be transmitted to reset transistor 103 from time t6 until time t7. Accordingly, reset transistor 103 may be turned on from time t6 until time t7, and/or the photocharges stored in first FD node FD1 may be transmitted to and/or stored in second FD node FD2.

For example, transmission control signal TG also may be transmitted to reset transistor 103, as indicated by reference numeral 250. For example, time t8 may be synchronized with time t6, and/or time t9 may be synchronized with time t7, so that transmission control signal TG at the active level may be transmitted to transmission transistor 101 while reset control signal RG at the active level may be transmitted to reset transistor 103.

As described above, reset transistor 103 may be used to reset first FD node FD1 and/or may be used as a passage for transmitting photocharges.

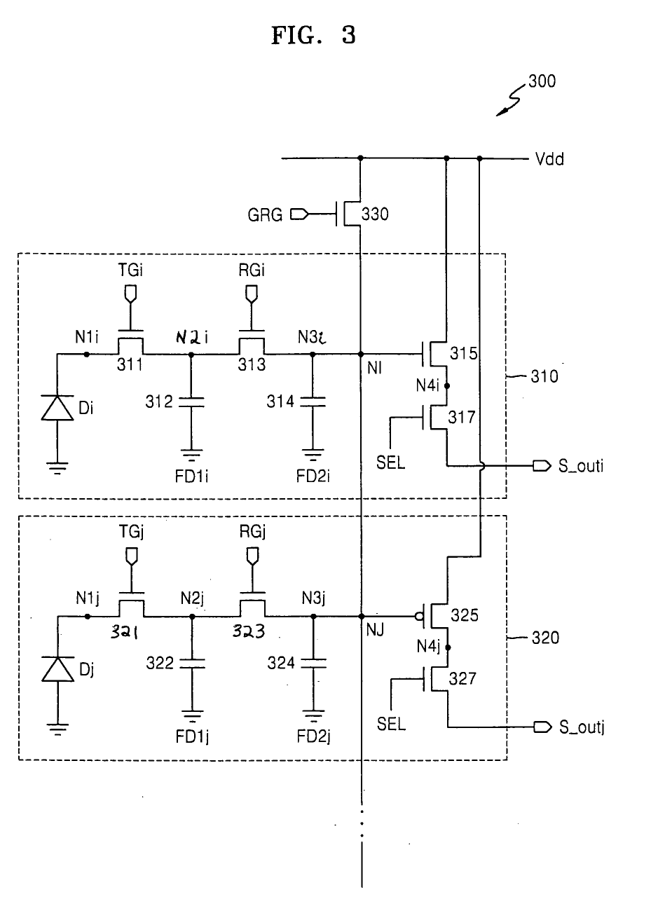

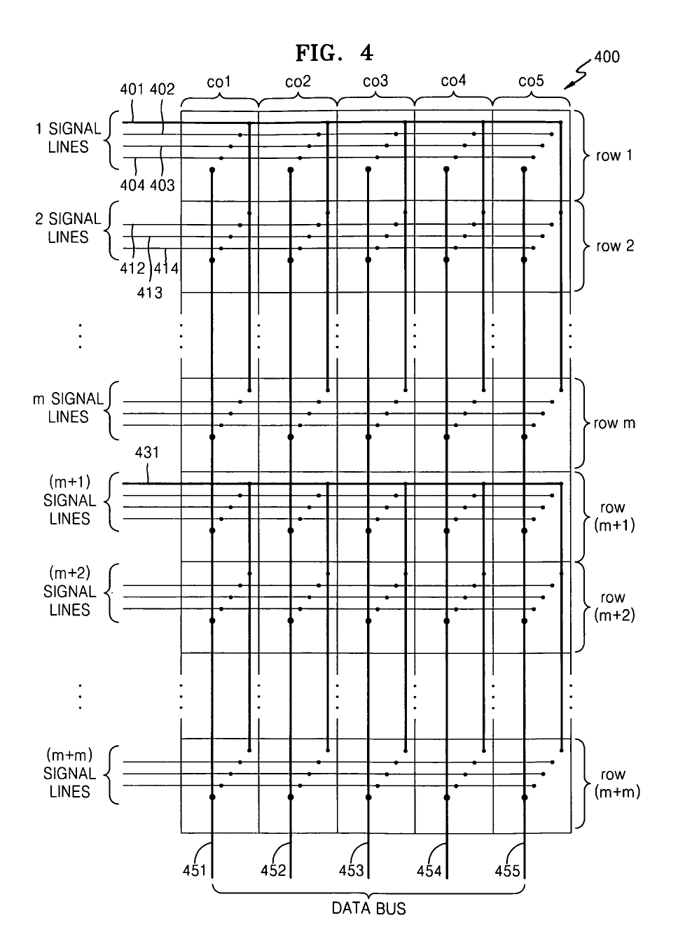

The global shutter operation will now be described with reference to FIGS. 3 and 4. FIG. 3 illustrates pixel circuit array 100 of FIG. 1 in more detail. The global shutter operation of pixel circuit array 100 of FIG. 1 will be described below with reference to FIG. 3. FIG. 4 is a general view of pixel circuit array 100 of FIG. 1.

Referring to FIG. 3, pixel circuit array 300 (that may be similar to pixel circuit array 100) may include global reset transistor 330 and/or a plurality of pixel circuits 310, 320, etc. (referred to in this specification as pixel circuits 310 and 320). Pixel circuits 310 and 320 may be arranged in the same column (additional pixel circuits may be arranged in one or more different columns). In addition or in the alternative, additional pixel circuits may be arranged in one or more different rows).

Pixel circuit 310 may include, for example, transmission transistor 311, reset transistor 313, source-follower transistor 315, and/or selection transistor 317. Pixel circuit 310 also may include, for example, photodiode Di, capacitor 312, capacitor 314, first FD node FD1i, and/or second FD node FD2i. Nodes N1i, N2i, N3i, N4i, and/or NI may be defined in pixel circuit 310. Pixel circuit 310 may be similar to pixel circuit 110.

Pixel circuit 320 may include, for example, transmission transistor 321, reset transistor 323, source-follower transistor 325, and/or selection transistor 327. Pixel circuit 320 also may include, for example, photodiode Dj, capacitor 322, capacitor 324, first FD node FD1j, and/or second FD node FD2j. Nodes N1j, N2j, N3j, N4j, and/or NJ may be defined in pixel circuit 320. Pixel circuit 320 may be similar to pixel circuit 110.

Global reset transistor 130 may be shared by pixel circuits 310 and 320. Pixel circuit array 300 may include ‘m’ pixel circuits. The ‘m’ pixel circuits may share global reset transistor 330. For example, ‘m’ may be determined by an allowable level of noise generation. For example, if an allowable number of pixel circuits when noise generation is taken into consideration is 16, a maximum value of ‘m’ may be determined to be 16.

In FIG. 4, a case where ‘m’ pixel circuits share one global reset transistor will be described as an example. A plurality of pixel circuits in the same column (i.e., an i^{th} column) may output image signals S_outi and S_outj through the same data bus. Thus, the pixel circuits arranged in the same column may not be able to simultaneously output respective image signals S_outi and S_outj. Instead, the pixel circuits may sequentially output image signals S_outi and S_outj on a column-by-column basis.

Referring to FIG. 4, signal lines 401 and/or 431 may be signals output. from global reset transistor 330 (, for example, signals transmitted to node NI in FIG. 3). Other signal lines 402 through 404 may indicate transmission control signal TG, selection control signal SEL, and/or reset control signal RG.

Since the ‘m’ pixel circuits may share global reset transistor 330, pixel circuits arranged in first through m^{th} rows (row 1 through row m of the same column) may share signal line 401, and pixel circuits arranged in (m+1)^{th} through (m+m)^{th} rows (row (m+1) through row (m+m) of the above column) may share signal line 431.

In a global shutter mode, transmission control signals TG for all pixel circuits may be simultaneously turned on and/or kept turned on for the same period of time. For example, transmission control signals TG may be transmitted to all pixel circuits, as may be indicated by reference numeral 240 (or 250) in FIG. 2.

Transmission control signal TG and/or reset control signal RG may be transmitted to pixel circuits in first row (row 1), as indicated by reference numeral 230 and 240 (or 250) in FIG. 2. Accordingly, output signals S_out generated by the pixel circuits in first row (row 1) may be output via data lines 451 through 455.

The time taken for a plurality of pixel circuits in a row to output image signals S_out is defined as a first time interval. The first time interval may vary according to specifications (such as the number of pixels arranged in a row and the transmission speed of a data bus) of an LCD.

Transmission control signal TG and/or reset control signal RG for pixel circuits in second row (row 2) may be turned on and/or transmitted to the pixel circuits. For example, transmission control signal TG and/or reset control signal RG may be simultaneously turned on and/or kept turned on for the same period of time.

For example, after transmission control signal TG is turned on during a first section, reset control signal RG may be turned on during a second section (as indicated by reference numerals 230, 240, and/or 250 in FIG. 2). Accordingly, image signals S_out generated by the pixel circuits in second row (row 2) may be output via data lines 451 through 455. The above operations may be repeated in the subsequent rows.

In order for the global shutter operation, a conventional pixel circuit may require additional elements (logic devices such as transistors and capacitors). In general, a pixel circuit may have a four-transistor (4TR) structure and, thus, may include four transistors (i.e., a transmission transistor, a reset transistor, a source-follower transistor, and a selection transistor). However, the above additional elements may have to be added to the conventional pixel circuit having the 4TR structure in order to implement the global shutter operation.

However, each unit pixel circuit according to example embodiments may include only four transistors. In addition, since a global reset transistor, that may be implemented outside pixel circuits, may be shared by every ‘m’ pixel circuits, it may not occupy a large space.

Therefore, a pixel circuit, that may operate using a global shutter without reducing a fill factor, may be provided. The fill factor may be defined as a proportion of a unit pixel circuit occupied by a photodiode. A larger photodiode may collect a greater amount of photocharges. Thus, as a photodiode occupies a greater proportion of a unit pixel circuit, the sensitivity of an image signal may be increased. However, since a conventional pixel circuit may include additional elements in order to support the global shutter operation, a proportion of the conventional unit pixel circuit occupied by a photodiode may be reduced even if the conventional unit pixel circuit is the same size as the unit pixel circuit according to example embodiments.

Since each pixel circuit in a pixel circuit array according to example embodiments may include only four transistors and/or may not include additional elements for the global shutter operation, the fill factor may not be reduced.

In a pixel circuit array according to example embodiments, a plurality of pixel circuits may share a global reset transistor. For example, a global shutter operation may be implemented without increasing the size of an image sensor and/or without reducing a fill factor.

Since the global shutter operation may be implemented without reducing the fill factor, the sensitivity of an output image signal may not be reduced. For example, the global shutter operation may be implemented while the image signal may have a higher quality than a predetermined level.

In addition, a first FD node having reduced leakage current may be formed without requiring additional elements. Thus, a global shutter may be implemented without a mechanical shutter.

While example embodiments have been particularly shown and described, it will be understood by those of ordinary skill in the art that various changes in form and details may be made therein without departing from the spirit and scope of the present invention as defined by the following claims.

What is claimed is:

1. A pixel circuit array, comprising:
a plurality of pixel circuits; and
a global reset transistor that has a first end connected to a second end of a reset transistor of each of the pixel circuits and is turned on or off in response to a global reset signal;
wherein each of the pixel circuits comprises:
a transmission transistor that receives photocharges from a photodiode through a first end of the transmission transistor and transmits the received photocharges through a second end of the transmission transistor in response to a transmission control signal;
the reset transistor that has a first end connected to the second end of the transmission transistor and is turned on or off in response to a reset control signal;
a source-follower transistor that receives a signal output from the second end of the reset transistor through a gate of the source-follower transistor and is turned on or off in response to the received signal; and
a selection transistor that is connected to the source-follower transistor and is turned on or off in response to a selection control signal.

2. The array of claim 1, wherein the global reset transistor has a second end connected to a high power supply voltage, and
wherein the global reset transistor is shared by the pixel circuits in a same column of an image sensor.

3. The array of claim 1, wherein each of the pixel circuits further comprises:
the photodiode;
wherein the photodiode is connected to the first end of the transmission transistor, and
wherein the photodiode receives light and accumulates photocharges.

4. The array of claim 1, wherein each of the pixel circuits further comprises:
a first floating diffusion (FD) node that is formed at the second end of the transmission transistor; and
a second FD node that is formed at the second end of the reset transistor.

5. The array of claim 4, wherein the first FD node comprises:
a first capacitor;
wherein the first capacitor has a first end connected to the second end of the transmission transistor, and
wherein the first capacitor has a second end connected to a ground source.

6. The array of claim 4, wherein the second FD node comprises:
a second capacitor;
wherein the second capacitor has a first end connected to the second end of the reset transistor, and
wherein the second capacitor has a second end connected to a ground source.

7. The array of claim 5, wherein no metal contact exists between the first end of the first capacitor and the ground source.

8. The array of claim 6, wherein metal contact exists between the first end of the second capacitor and the ground source.

9. The array of claim 1, wherein the reset control signal transits from an active level to an inactive level at a first time,
wherein the global reset signal transits from the active level to the inactive level at a second time, and
wherein the second time is after the first time.

10. The array of claim 9, wherein the transmission control signal at the active level is transmitted during a first section from a third time, and
wherein the third time is after the second time.

11. The array of claim 10, wherein the reset control signal at the active level is transmitted during a second section, and
wherein the second section is after the first section.

12. The array of claim 9, wherein the transmission control signal at the active level is transmitted during a third section after the second time, and
wherein the reset control signal at the active level is transmitted during at least a portion of the third section.

13. The array of claim 2, wherein in a global shutter mode, transmission transistors of the pixel circuits arranged in the same column of the image sensor are simultaneously turned on in a fourth section, and
wherein reset transistors of the pixel circuits arranged in the same column of the image sensor are sequentially turned on after the fourth section at a first time interval and on a row-by-row basis.

14. The array of claim 4, wherein the first FD node is reset when the global reset transistor and the reset transistor are both turned on, and
wherein the second FD node is reset when the global reset transistor is turned on.

15. The array of claim 1, wherein one or more of the reset transistor, the transmission transistor, the source-follower transistor, and the selection transistor included in at least one of the pixel circuits are n-type metal oxide semiconductor (NMOS) transistors.

16. The array of claim 1, wherein the reset transistor, the transmission transistor, the source-follower transistor, and the selection transistor included in at least one of the pixel circuits are n-type metal oxide semiconductor (NMOS) transistors.

17. The array of claim 1, wherein the reset transistor, the transmission transistor, the source-follower transistor, and the selection transistor included in each of the pixel circuits are n-type metal oxide semiconductor (NMOS) transistors.

18. The array of claim 1, wherein the pixel circuits are arranged in a plurality of columns.

19. The array of claim 1, wherein the pixel circuits are arranged in a plurality of rows.

20. The array of claim 1, wherein the pixel circuits are arranged in a plurality of rows and columns.
